(19) United States
(12) Patent Application Publication
(10) Pub. No.: US 2017/0031317 A1
(43) Pub. Date: Feb. 2, 2017

(54) HOLOGRAPHIC IMAGE DISPLAY

(71) Applicant: EMPIRE TECHNOLOGY DEVELOPMENT LLC, Wilmington, DE (US)

(72) Inventor: Hyun Oh Oh, Gwacheon-si (KR)

(73) Assignee: EMPIRE TECHNOLOGY DEVELOPMENT LLC, Wilmington, DE (US)

(21) Appl. No.: 15/302,503

(22) PCT Filed: Apr. 9, 2014
(86) PCT No.: PCT/US2014/033571

§ 371 Date: Oct. 7, 2016

(51) Int. Cl. G03H 1/04; G03H 1/12

(52) U.S. Cl. CPC G03H 1/0402; G03H 1/12; G03H 2226/04; G03H 2222/42; G03H 2222/43; G03H 2227/02; G03H 2210/30; G03H 2001/0088

(57) ABSTRACT

Briefly stated, technologies are generally described for displaying a holographic image on a mobile device with a reference beam provided from a light source station. Example devices/systems described herein may use one or more of a mobile device and/or one or more light source stations. In various examples, the mobile device may include a holographic image display unit configured to receive a reference beam and display the holographic image responsive to the reference beam. The light source station may be configured to track a location of the holographic image display unit and provide a reference beam towards the holographic image display unit. The light source station may be further configured to exchange a control signal with the mobile device such that the holographic image display unit is operable to display the holographic image based on the control signal.

### BACKGROUND

Unless otherwise indicated herein, the approaches described in this section are not prior art to the claims in this application and are not admitted to be prior art by inclusion in this section.

Holography techniques can be used to record holograms representing images of an object and reconstruct the images from the recorded holograms. As an example of conventional holography techniques, transmission-type holography techniques may be employed where object and reference beams are incident on the recording medium from the same side. On the other hand, in reflection-type holography techniques, object and reference beams are incident respectively on opposite sides of the recording medium. The reconstructed object is then viewed from the same side of the recording medium as that at which the reference beam is incident.

The reflection-type holography techniques have the advantage of a wider viewing angle and better depth of field, compared with the transmission-type holography techniques. However, the reflection-type holography techniques may not be appropriate for being employed in a mobile device because a light source for the reference beam may not be readily arranged on a front side (e.g., a holographic display unit) of the mobile device due to its size constraints.

### SUMMARY

Technologies generally described herein relate to a holographic image display.

Various example apparatus configured to display a holographic image described herein may include one or more of a mobile device and/or a light source station. The mobile device may include a holographic image display unit. The light source station may be configured to track a location of the holographic image display unit and provide a reference beam towards the holographic image display unit. The light source station may be further configured to exchange a control signal with the mobile device such that the holographic image display unit is operable to display the holographic image based on the control signal.

In some examples, methods of displaying a holographic image are described. Example methods may include tracking, by one or more light source stations, a location of a mobile device including a holographic image display unit. A reference beam may be provided, by the one or more light source stations, towards the holographic image display unit. Further, a control signal may be exchanged, by the one or more light source stations, with the mobile device.

In some examples, a computer-readable storage medium may store a program for causing a processor to display a holographic image on a holographic display unit of a mobile device. The program may include one or more instructions for receiving, by the mobile device, a control signal from a light source station, and for displaying the holographic image on the holographic display unit of the mobile device using light from the light source station as a reference beam, such that the holographic image display unit is operable to display the holographic image based on the control signal. In some examples, example mobile devices configured to display a holographic image with a reference beam are described. Example mobile devices may include one or more of a holographic image display unit and/or a receiver. The holographic image display may be configured to receive the reference beam and display the holographic image responsive to the reference beam. The receiver may be configured to receive a control signal from the light source station such that the holographic image display unit is time-synchronized with the light source station responsive to the control signal.

In some examples, example light source stations for providing a time-synchronized reference beam for a holographic display unit are described. Example light source stations may include one or more of a reference beam source, a directional controller, a control signal generator, a holographic display detection unit, and/or a control circuit. The reference beam source may be configured to generate a reference beam. The directional controller may be operable to control a direction of the reference beam. The control signal generator may be operable to generate a control signal. The holographic display detection unit may be operable to detect the holographic display unit within an environment of the light source station and provide display detection data. The control circuit may be operable to energize the reference beam source to produce the reference beam, and to provide direction control signals to the directional controller to direct the reference beam towards the holographic display unit using the display detection data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 schematically shows a diagram of an example system including a light source station and a mobile device, where the system may be configured to display a holographic image on a holographic image display unit of the mobile device;

FIG. 2 schematically shows a block diagram of an example light source station configured to provide a time-synchronized reference beam for a holographic display unit;

FIG. 3 schematically shows a block diagram of an example mobile device configured to display a holographic image with a reference beam provided from a light source station;

FIGS. 4A and 4B schematically show diagrams of an example system including a mobile device and a plurality of light source stations, where a handover operation may be performed between the plurality of light source stations;

FIG. 5 schematically shows a diagram of an example system including a mobile device and a light source station, where the light source station provide a reference beam towards a holographic image display unit of the mobile device that is positioned in a predetermined location;

FIG. 6 illustrates an example flow diagram of a method adapted to display a holographic image;

FIG. 7 shows a schematic block diagram illustrating an example computing system that can be configured to display a holographic image on a holographic display unit of a mobile device; and

FIG. 8 illustrates computer program products that can be utilized to display a holographic image on a holographic display unit of a mobile device, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices and computer program products related to displaying a holographic image.

Briefly stated, technologies are generally described for displaying a holographic image on a mobile device with a reference beam provided from a light source station. Example devices/systems described herein may use one or more of a mobile device and/or one or more light source stations. In various examples, a mobile device is described, where the mobile device may be configured to display a holographic image with a reference beam provided from a light source station. The mobile device may include a holographic image display unit configured to receive the reference beam and display the holographic image in response to the reference beam, and/or a receiver configured to receive a control signal from the light source station such that the holographic image display unit is time-synchronized with the light source station in response to the control signal. In some other examples, a light source station is described, where the light source station may be configured to provide a time-synchronized reference beam for a holographic image display unit. The light source stations may include a reference beam source configured to generate a reference beam, a directional controller that is operable to control a direction of the reference beam, a control signal generator operable to generate a control signal, a holographic display detection unit that is operable to detect the holographic image display unit within an environment of the light source station and provide display detection data, and/or a control circuit. The control circuit may be operable to energize the reference beam source to produce the reference beam, and to provide direction control signals to the directional controller to direct the reference beam towards the holographic image display unit using the display detection data.

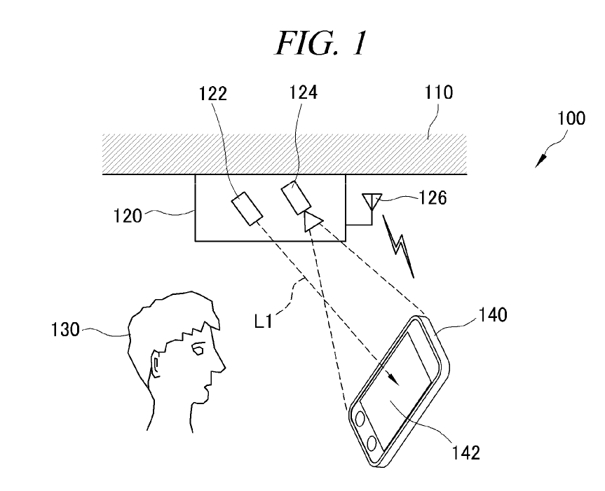

FIG. 1 schematically shows a diagram of an example system including a light source station and a mobile device, where the system may be configured to display a holographic image on a holographic image display unit of the mobile device, arranged in accordance with at least some embodiments described herein. As depicted, a holographic image display system 100 may include one or more of a light source station 120 and/or a mobile device 140 including a holographic image display unit 142 such as an SLM (spatial light modulator). Light source station 120 may be installed at a predetermined location such as a ceiling or wall 110 of a room. Also, mobile device 140 may be held by a user 130 and/or may change its position as user 130 walks around in the room or moves/rotates mobile device 140 in various directions. In some embodiments, light source station 120 may include one or more of a reference beam source 122, a holographic display detection unit 124, and/or a wireless communication antenna 126.

In operation, light source station 120 may be configured to exchange a control signal with mobile device 140 through wireless communication antenna 126, such that holographic image display unit 412 is operable to display a holographic image based on the control signal. For example, when user 130 holding mobile device 140 enters the room, mobile device 140 may attempt to communicate with light source station 120. For this purpose, a communication channel such as a wireless communications link may be established between mobile device 140 and light source station 120. In some embodiments, the communication channel may include at least one of Bluetooth, Zigbee, RFID, Wi-Fi, or cellular network. Alternatively, the communication channel may include an in-band communication channel in a light beam generated from reference beam source 122 of light source station 120. Once the communication channel is established between mobile device 140 and light source station 120, mobile device 140 may receive a control signal from light source station 120. The control signal may include information on permission to use light source station 120 and/or parameters required to drive holographic image display unit 142 to display a holographic image. Also, holographic image display unit 142 may be time-synchronized with light source station 120 in response to the control signal. For example, holographic image display unit 142 may be time synchronized (or phase-locked) with light source station 120 based on phase information of a reference beam to be generated from light source station 120.

In some embodiments, if mobile device 140 is to display a holographic image on holographic image display unit 142, mobile device 140 may transmit parameters associated with the holographic image to light source station 120 through the communication channel. The parameters may include at least one of a frequency, an amplitude, a phase, and an incident angle of a reference beam to be generated from light source station 120. Based on such parameters, reference beam source 122 of light source station 120 may generate and provide a reference beam towards holographic image display unit 142. Additionally, holographic display detection unit 124 of light source station 120 may be configured to track a location of holographic image display unit 142 of mobile device 140. In some embodiments, holographic display detection unit 124 may include an image sensor configured to capture an image of holographic image display unit 142 and determine the location of holographic image display unit 142 based on the captured image. In some other embodiments, holographic display detection unit 124 may track a location of holographic image display unit 142 based at least one of an RSSI (received signal strength indicator) of the control signal, an IR (infrared) signal or a sound signal such as a ultrasonic signal transmitted from mobile device 140, or any other type of location sensing information such as gyroscope sensor output, accelerometer output or inertial sensor output from mobile device 140.

In some embodiments, system 100 may include a plurality of light source stations including light source station 120 and a second light source station. In this case, at least one of the plurality of light source stations may perform a location tracking function to track the location of holographic image display unit 142 in a similar manner as described above. For example, one of the plurality of light source stations may be selected to perform the location tracking function depending various factors such as an actual location of mobile device 140, an incident angle of a reference beam generated from the light source station, etc., which will be described later in detail.

In some embodiments, light source station 120 may provide a coherent light beam such as a laser beam as the reference beam. In this case, light source station 120 may track an accurate location of holographic image display unit 142 for providing a reference beam with a suitable incident angle towards holographic image display unit 142. For this purpose, a plurality of light source stations including light source station 120 may be installed over a substantially entire surface of ceiling 110, such that each of the light source stations are spaced substantially at equal distances from a neighboring light source station. In this configuration, one of the plurality of light source stations may be selected to provide a reference beam with a suitable incident angle towards holographic image display unit 142. Additionally, the selected light source station may provide a reference beam while the other light source stations may not provide the reference beam for electricity energy saving.

Alternatively, light source station 120 may provide a white light beam as the reference beam. In this case, the accuracy of the location tracking by light source station 120 may be less significant than the case of using a coherent light beam. Thus, one light source station 120 may be installed on ceiling 110, such that light source station 120 may provide a reference beam with a suitable incident angle towards holographic image display unit 142 if it is located within a predetermined area below or in proximity to light source station 120. Additionally, the white light generated from light source station 120 may also function as room lighting.

In some embodiments, light source station 120 may perform line of sight communication with mobile device 140. More specifically, reference beam source 122 of light source station 120 and holographic image display unit 142 of mobile device 140 may be in a view of each other without any obstacle that blocks propagation of a reference beam between them. If light source station 120 and mobile device 140 are not positioned at such light of sight locations, light source station 120 may determine that the location of holographic image display unit 142 fails to track. Alternatively, if light source station 120 and mobile device 140 are not positioned at such light of sight locations, mobile device 140 may determine that the control signal is not received by mobile device 140 any longer. In such cases, since the reference beam does not reach holographic image display unit 142, a required three-dimensional holographic image may not be generated and displayed on holographic image display unit 142. Thus, holographic image display unit 142 may be configured to convert the holographic image into a two-dimensional image that can be displayed in the absence of the reference beam. Such two-dimension image may be pre-stored in an external device (not shown) connected with mobile device 140 and may be provided to mobile device 140 in the absence of the reference beam.

In some embodiments, holographic image display unit 142 may be configured to record a holographic image based on an object beam, which may be a reference beam generated and provided from light source station 120. For example, in a two-way video communication scenario, light source station 120 may generate and provide a light beam as the object beam for recording a holographic image of user 130, and mobile device 140 may transmit the recorded holographic image to a remote mobile device (not shown). Also, mobile device 140 may be provided with the same light beam by light source station 120 as a reference beam for generating and displaying a holographic image transmitted from the remote mobile device.

In some embodiments, light source station 120 may be configured to control accessibility of mobile device 140 to light source station 120. For example, mobile device 140 may be allowed to access or communicate with light source station 120 if mobile device 140 has subscribed to a holographic image display service by light source station 120. The accessibility of mobile device may be determined when mobile device 140 transmit user ID information to light source station 120 in the process of establishing a communication channel with light source station 120. In some other embodiments, the accessibility of mobile device 140 may be determined depending on contents of a holographic image to be displayed on mobile device 140. In some other embodiments, mobile device 140 may be provided with priority for accessing light source station 120, where the priority may be determined based on the service subscription level of mobile device 140.

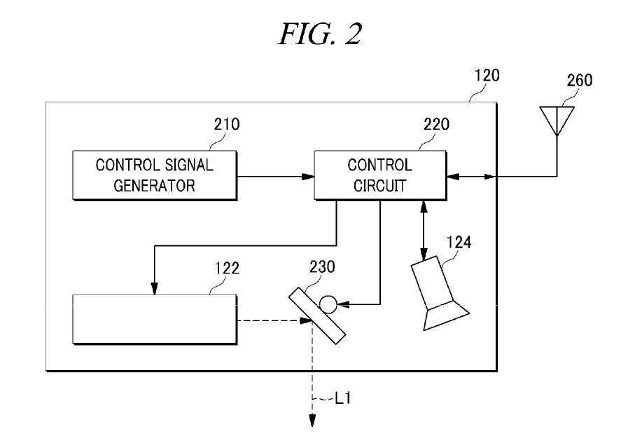

FIG. 2 schematically shows a block diagram of an example light source station configured to provide a time-synchronized reference beam for a holographic display unit, arranged in accordance with at least some embodiments described herein. As illustrated, a light source station 120 may include one or more of a control signal generator 210, a control circuit 220, a reference beam source 122, a directional controller 230, and/or a holographic display detection unit 124.

In some embodiments, control signal generator 210 may be configured to generate a control signal and provide the control signal to control circuit 220. Control circuit 220 may be configured to transmit the control signal through wireless communication antenna 260 to mobile device 140, such that holographic image display unit 142 of mobile device 140 is operable to display a holographic image based on the control signal. The control signal may include time synchronization data for holographic image display unit 142, information on permission to use light source station 120 and/or parameters required to drive holographic image display unit 142 to display a holographic image.

In some embodiments, holographic display detection unit 124 may be configured to detect holographic image display unit 142 within an environment of light source station 120 and provide display detection data. For example, holographic display detection unit 124 may include an image sensor configured to capture an image of holographic image display unit 142 and track the location of holographic image display unit 142 based on the captured image. In some other examples, holographic display detection unit 124 may track a location of holographic image display unit 142 based at least one of an RSSI (received signal strength indicator) of the control signal, an IR (infrared) signal or a sound signal such as a ultrasonic signal transmitted from mobile device 140, or any other type of location sensing information such as gyroscope sensor output, accelerometer output or inertial sensor output from mobile device 140.

In some embodiments, control circuit 220 may be configured to energize reference beam source 122 to generate reference beam L1, and to provide directional control signals to directional controller 230 to direct reference beam L1 towards holographic image display unit 142 using the display detection data. In some embodiments, the reference beam may include coherent radiation such as a laser beam or a white light beam. Also, directional controller 230 may include a mirror configured to be actuated mechanically, electrostatically or electromechanically based on the directional control signals.

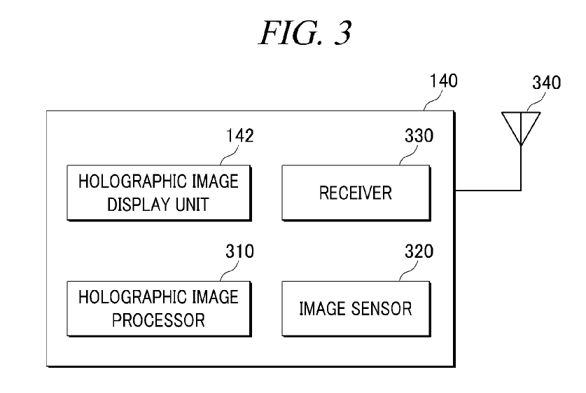

FIG. 3 schematically shows a block diagram of an example mobile device configured to display a holographic image with a reference beam provided from a light source station, arranged in accordance with at least some embodiments described herein. As depicted, a mobile device 140 may include one or more of a holographic image display unit 142, a holographic image processor 310, an image sensor 320 and/or a receiver 330. Mobile device 140 may be any suitable type of mobile device with wireless communication capability, such as a cellular telephone, a smartphone, a portable computer, etc.

In some embodiments, holographic image display unit 142 may be configured to receive a reference beam from light source station 120 and display a holographic image in response to the reference beam. Holographic image display unit 142 may include an SLM that may be time-synchronized with the reference beam in response to the control signal.

In some embodiments, receiver 330 may be configured to receive a control signal from light source station 120 through a wireless communication antenna 340, such that holographic image display unit 142 may be time-synchronized with light source station 120 in response to the control signal. Mobile device 140 may be configured to establish a communication channel with light source station 120, such that the control signal may be communicated to mobile device 140 over the communication channel. The communication channel may include a wireless communications link or data encoded in the reference beam.

In some embodiments, mobile device 140 may be further configured to receive image data through wireless communication antenna 340 from an external device (not shown). Holographic image processor 310 may be configured to process the image data to generate a holographic image to be displayed on holographic image display unit 142. For example, the image data may include three-dimensional holographic image data or two-dimensional image data that can be displayed instead of the three-dimensional holographic image data in the absence of the reference beam.

In some embodiments, image sensor 320 may be optionally installed in mobile device 140 for accurate tracking of the location of mobile device 140 by light source station 120. For example, image sensor 320 may capture an image of light source station 120 and determine whether light source station 120 and mobile device 140 are positioned at light of sight locations, e.g., whether light source station 120 is in view of mobile device 140 without any obstacle blocking the propagation of a reference beam between them, based on the captured image. Further, mobile device 140 may transmit to light source station 120 information on whether mobile device 140 and light source station 120 are positioned at line of sight locations.

Additionally or alternatively, mobile device 140 may include a gyroscope sensor, an accelerometer and/or an inertial sensor. For more accurate tracking of the location of mobile device 140 by light source station 120, mobile device 140 may transmit to light source station 120 information on the output of at least one of the gyroscope sensor, the accelerometer and/or the inertial sensor. Further, mobile device 140 may transmit to light source station 120 information on an RSSI of the control signal, an IR signal or a sound signal such as an ultrasonic signal.

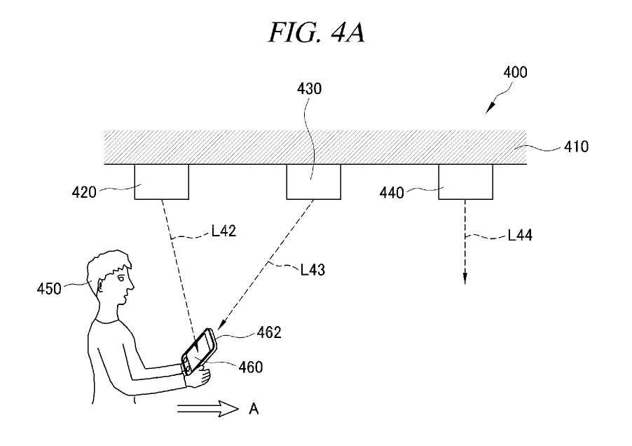

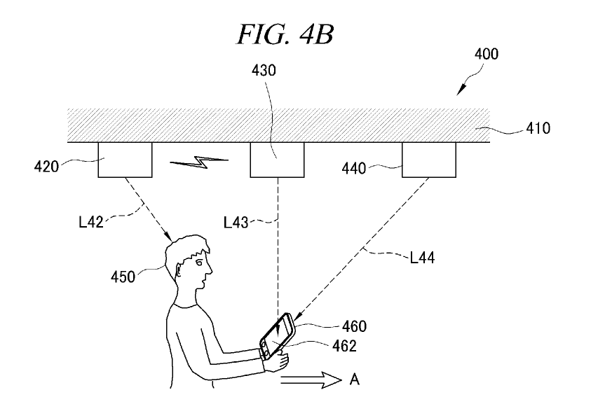

FIGS. 4A and 4B schematically show diagrams of an example system including a mobile device and a plurality of light source stations, where a handover operation may be performed between the plurality of light source stations, arranged in accordance with at least some embodiments described herein. In a system 400 as depicted in FIG. 4A, a plurality of light source stations 420, 430 and 440 may be installed on at predetermined locations, which may be spaced substantially equally apart from each other, on a ceiling 410 of a space such as a room, a compartment in a train, etc. Each of light source stations 420 to 440 may be configured to track a location of a mobile device 460 or a holographic image display unit 462 of mobile device 460. In some embodiments, light source stations 420 to 440 may include a similar configuration to light source station 120 as illustrated in FIG. 2. Further, mobile device 460 may include a similar configuration to mobile device 140 as illustrated in FIG. 3.

In operation, when a user 450 enters the room, light source station 420 may exchange a control signal with mobile device 460 held by user 450, such that holographic image display unit 462 may display a holographic image based on the control signal. Also, holographic image display unit 462 may be time-synchronized with light source station 420 in response to the control signal. For example, holographic image display unit 462 may be time synchronized (or phase-locked) with light source station 420 based on phase information of a reference beam to be generated from light source station 420. Mobile device 460 may transmit parameters associated with the holographic image to light source station 420. The parameters may include at least one of a frequency, an amplitude, a phase, and an incident angle of a reference beam to be generated from light source station 420. Based on the parameters, light source station 420 may generate and provide a reference beam L42 towards holographic image display unit 462.

While user 450 moves around in the room, light source station 420 may track the location of holographic image display unit 142, e.g., by capturing an image of holographic image display unit 142 using an image sensor. Further, as user 450 moves more proximately to light source station 430 (e.g., in a direction A as shown in FIG. 4A), light source station 430 may be operable to detect and track holographic image display unit 462 located within an environment of light source station 430. In this case, if light source station 420 can provide reference beam L42 with a better incident angle than a reference beam L43 that can be provided from light source station 430, light source station 420 may continue to provide reference beam L42 towards holographic image display unit 462.

As depicted in FIG. 4B, as user 450 moves more proximately to light source station 430 in direction A and holographic image display unit 462 is positioned within an environment of light source station 430, light source station 420 may not be able to provide reference beam L42 with a better incident angle than reference beam L43 any longer. In this case, light source station 420 or mobile device 460 may perform a handover operation between light source stations 420 and 430.

For example, if light source station 420 and holographic image display unit 462 are not at light of sight locations due to user 450 that blocks propagation of reference beam L42 between them, light source station 420 may determine that the location of holographic image display unit 462 fails to track. In some other examples, if light source station 420 and holographic image display unit 462 are not at light of sight locations, mobile device 460 may determine that the control signal is not received by mobile device 460 any longer. In these cases, light source station 420 or mobile device 460 may perform a handover operation between light source stations 420 and 430.

After the handover operation is completed between light source stations 420 and 430, light source station 430 may exchange a control signal with mobile 460, such that holographic image display unit 462 may continue to display a holographic image based on the control signal. Also, holographic image display unit 462 may be time-synchronized with light source station 430 in response to the control signal. Mobile device 460 may transmit parameters associated with the holographic image to light source station 430. The parameters may include at least one of a frequency, an amplitude, a phase, and an incident angle of a reference beam to be generated from light source station 430. Based on the parameters, light source station 430 may generate and provide reference beam L43 towards holographic image display unit 462.

Further, as user 450 moves more proximately to light source station 440, light source station 440 may be operable to detect and track holographic image display unit 462 located within an environment of light source station 440. In this case, as long as light source station 430 can provide reference beam L43 with a better incident angle than a reference beam L44 that can be provided from light source station 440, light source station 430 may continue to provide reference beam L43 towards holographic image display unit 462.

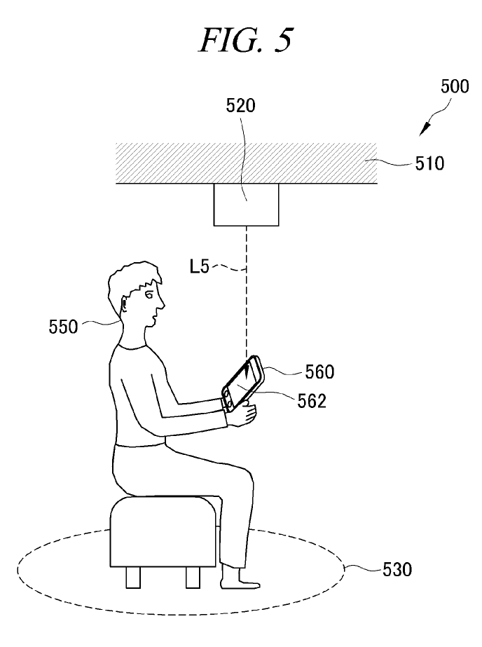

FIG. 5 schematically shows a diagram of an example system including a mobile device and a light source station, where the light source station provide a reference beam towards a holographic image display unit of the mobile device that is positioned in a predetermined location, arranged in accordance with at least some embodiments described herein. In a system 500 as depicted in FIG. 5, a light source station 520 may be installed at a predetermined location on a ceiling 510 of a space such as a room, a compartment in a train, etc. Light source station 520 may be configured to track a location of a mobile device 460 or a holographic image display unit 562 of mobile device 560, such that light source station 520 may provide a reference beam L5 towards the tracked location. Alternatively, light source station 520 may be configured to provide reference beam L5 towards a predetermined area 530, if mobile device 560 is detected to be positioned within area 530. In some embodiments, light source station 520 and mobile device 560 may include a similar configuration to light source station 120 and mobile device 140 as illustrated in FIGS. 2 and 3, respectively.

In operation, when a user 550 enters area 530 (e.g., sits on a seat installed on area 530 as depicted in FIG. 5), light source station 520 may exchange a control signal with mobile device 560 held by user 550, such that holographic image display unit 562 may display a holographic image based on the control signal. Also, holographic image display unit 562 may be time-synchronized with light source station 520 in response to the control signal. For example, holographic image display unit 562 may be time synchronized (or phase-locked) with light source station 520 based on phase information of a reference beam to be generated from light source station 520. Mobile device 560 may transmit parameters associated with the holographic image to light source station 520. The parameters may include at least one of a frequency, an amplitude, a phase, and an incident angle of a reference beam to be generated from light source station 520. Based on the parameters, light source station 520 may generate and provide reference beam L5 towards area 530 where holographic image display unit 562 is positioned.

In some embodiments, when user 550 moves out of area 530, light source station 520 may determine that the location of holographic image display unit 562 fails to track. Alternatively, when user 550 moves out of area 530, mobile device 560 may determine that the control signal is not received by mobile device 560 any longer. In this case, light source station 520 may stop providing reference beam L5 or mobile device 560 may stop displaying the holographic image on holographic image display unit 562.

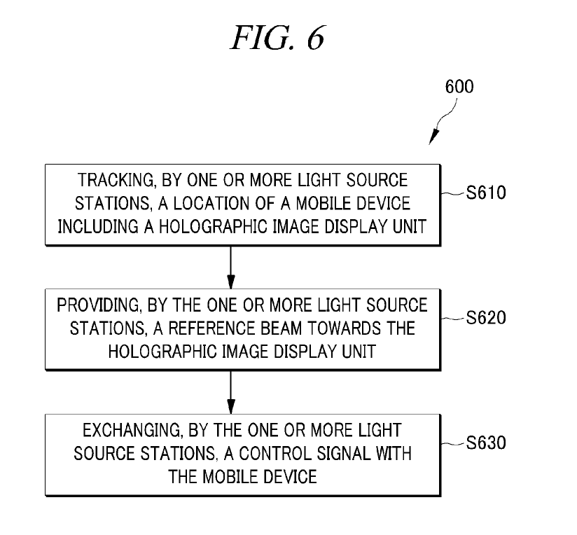

FIG. 6 illustrates an example flow diagram of a method adapted to display a holographic image, arranged in accordance with at least some embodiments described herein. An example method 600 in FIG. 6 may be implemented using, for example, a computing device including a processor adapted to display a holographic image on a holographic display unit of a mobile device.

Method 600 may include one or more operations, actions, or functions as illustrated by one or more of blocks S610, S620, and/or S630. Although illustrated as discrete blocks, various blocks may be divided into additional blocks, combined into fewer blocks, or eliminated, depending on the desired implementation. In some further examples, the various described blocks may be implemented as a parallel process instead of a sequential process, or as a combination thereof. Method 600 may begin at block S610, “TRACKING, BY ONE OR MORE LIGHT SOURCE STATIONS, A LOCATION OF A MOBILE DEVICE INCLUDING A HOLOGRAPHIC IMAGE DISPLAY UNIT.”

At block S610, a location of a mobile device including a holographic image display unit may be tracked, by one or more light source stations. As depicted in FIGS. 1 to 3, light source station 120 or holographic display detection unit 124 may be configured to track a location of holographic image display unit 142 of mobile device 140. In some embodiments, holographic display detection unit 124 may include an image sensor configured to capture an image of holographic image display unit 142 and determine the location of holographic image display unit 142 based on the captured image. Block S610 may be followed by block S620, “PROVIDING, BY THE ONE OR MORE LIGHT SOURCE STATIONS, A REFERENCE BEAM TOWARDS THE HOLOGRAPHIC IMAGE DISPLAY UNIT.”

At block S620, a reference beam may be provided, by the one or more light source stations, towards the holographic image display unit. As illustrated in FIGS. 1 to 3, light source station 120 or reference beam source 122 may generate and provide a reference beam towards holographic image display unit 142. In some embodiments, light source station 120 may provide a coherent light beam such as a laser beam or a white light beam as the reference beam. In some embodiments, holographic image display unit 142 may record a holographic image based on the reference beam, e.g., in a two-way video conference scenario. Block S620 may be followed by block S630, “EXCHANGING, BY THE ONE OR MORE LIGHT SOURCE STATIONS, A CONTROL SIGNAL WITH THE MOBILE DEVICE.”

At block S630, a control signal may be exchanged, by the one or more light source stations, with the mobile device. As illustrated in FIGS. 1 to 3, light source station 120 may be configured to exchange a control signal with mobile device 140 through wireless communication antenna 126, such that holographic image display unit 412 is operable to display a holographic image based on the control signal. In some embodiments, the control signal may include information on permission to use light source station 120 and/or parameters required to drive holographic image display unit 142. Also, holographic image display unit 142 may be time-synchronized (or phase-locked) with light source station 120 responsive to the control signal.

In some embodiments, a communication channel for transmitting the control signal may be established with at least one of the one or more light source stations, by the mobile device. The communication channel may include an in-band communication channel in the reference beam or at least one of Bluetooth, Zigbee, RFID, Wi-Fi, or a cellular network.

In some embodiments, a handover operation may be performed, by the mobile device, between the one or more light source stations. Further, accessibility of the mobile device may be controlled by the one or more light source stations. In some other embodiments, the holographic image may be converted into a two-dimensional image, by the holographic image display unit, when the one or more light source stations determine that the location of the holographic image display unit fails to track.

In light of the present disclosure, one skilled in the art will appreciate that, for this and other methods disclosed herein, the functions performed in the methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

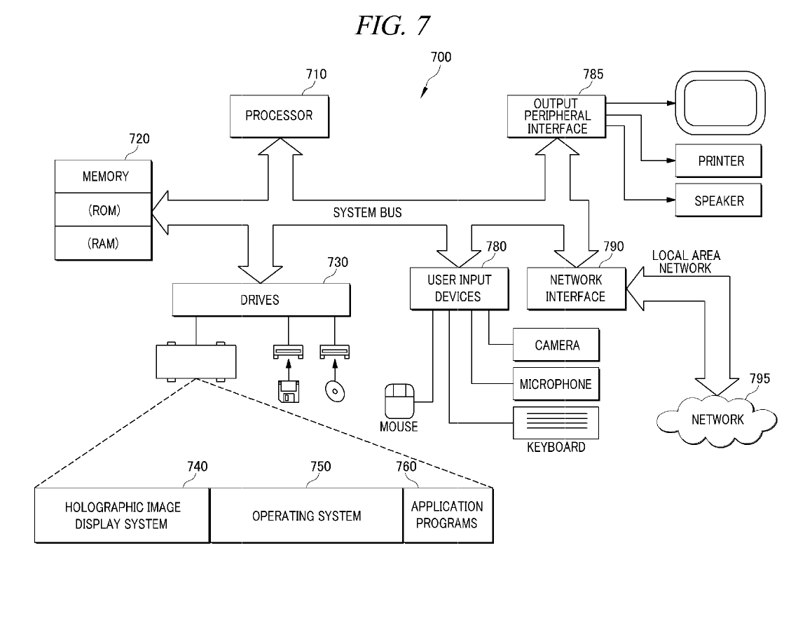

FIG. 7 shows a schematic block diagram illustrating an example computing system that can be configured to display a holographic image on a holographic display unit of a mobile device, arranged in accordance with at least some embodiments described herein. As depicted in FIG. 7, a computer 700 may include a processor 710, a memory 720 and one or more drives 730. Computer 700 may be implemented as a conventional computer system, an embedded control computer, a laptop, or a server computer, a mobile device, a set-top box, a kiosk, a vehicular information system, a mobile telephone, a customized machine, or other hardware platform.

Drives 730 and their associated computer storage media may provide storage of computer readable instructions, data structures, program modules and other data for computer 700. Drives 730 may include a holographic image display system 740, an operating system (OS) 750, and application programs 760. Holographic image display system 740 may be adapted to display a holographic image on a holographic image display unit of a mobile device in such a manner as described above with respect to FIGS. 1 to 6.

Computer 700 may further include user input devices 780 through which a user may enter commands and data. Input devices can include an electronic digitizer, a camera, a microphone, a keyboard and pointing device, commonly referred to as a mouse, trackball or touch pad. Other input devices may include a joystick, game pad, satellite dish, scanner, or the like.

These and other input devices can be coupled to processor 710 through a user input interface that is coupled to a system bus, but may be coupled by other interface and bus structures, such as a parallel port, game port or a universal serial bus (USB). Computers such as computer 700 may also include other peripheral output devices such as display devices, which may be coupled through an output peripheral interface 785 or the like.

Computer 700 may operate in a networked environment using logical connections to one or more computers, such as a remote computer coupled to a network interface 790. The remote computer may be a personal computer, a server, a router, a network PC, a peer device or other common network node, and can include many or all of the elements described above relative to computer 700.

Networking environments are commonplace in offices, enterprise-wide area networks (WAN), local area networks (LAN), intranets, and the Internet. When used in a LAN or WLAN networking environment, computer 700 may be coupled to the LAN through network interface 790 or an adapter. When used in a WAN networking environment, computer 700 typically includes a modem or other means for establishing communications over the WAN, such as the Internet or a network 795. The WAN may include the Internet, the illustrated network 795, various other networks, or any combination thereof. It will be appreciated that other mechanisms of establishing a communications link, ring, mesh, bus, cloud, or network between the computers may be used.

In some embodiments, computer 700 may be coupled to a networking environment. Computer 700 may include one or more instances of a physical computer-readable storage medium or media associated with drives 730 or other storage devices. The system bus may enable processor 710 to read code and/or data to/from the computer-readable storage media. The media may represent an apparatus in the form of storage elements that are implemented using any suitable technology, including but not limited to semiconductors, magnetic materials, optical media, electrical storage, electrochemical storage, or any other such storage technology. The media may represent components associated with memory 720, whether characterized as RAM, ROM, flash, or other types of volatile or nonvolatile memory technology. The media may also represent secondary storage, whether implemented as storage drives 730 or otherwise. Hard drive implementations may be characterized as solid state, or may include rotating media storing magnetically encoded information.

Processor 710 may be constructed from any number of transistors or other circuit elements, which may individually or collectively assume any number of states. More specifically, processor 710 may operate as a state machine or finite-state machine. Such a machine may be transformed to a second machine, or specific machine by loading executable instructions. These computer-executable instructions may transform processor 710 by specifying how processor 710 transitions between states, thereby transforming the transistors or other circuit elements constituting processor 710 from a first machine to a second machine. The states of either machine may also be transformed by receiving input from user input devices 780, network interface 790, other peripherals, other interfaces, or one or more users or other actors. Either machine may also transform states, or various physical characteristics of various output devices such as printers, speakers, video displays, or otherwise.

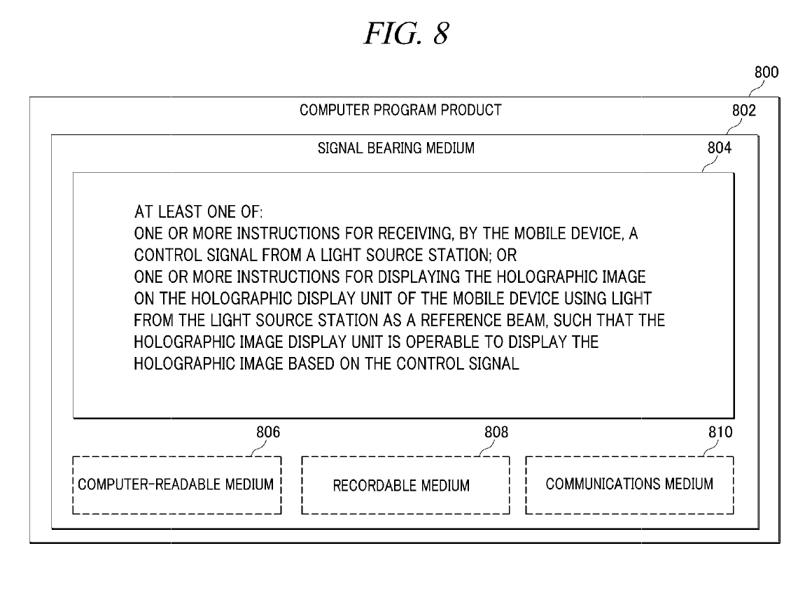

FIG. 8 illustrates computer program products that can be utilized to display a holographic image on a holographic display unit of a mobile device, in accordance with at least some embodiments described herein. Program product 800 may include a signal bearing medium 802. Signal bearing medium 802 may include one or more instructions 804 that, when executed by, for example, a processor, may provide the functionality described above with respect to FIGS. 1 to 6. By way of example, instructions 804 may include at least one of: one or more instructions for receiving, by the mobile device, a control signal from a light source station; or one or more instructions for displaying the holographic image on the holographic display unit of the mobile device using light from the light source station as a reference beam, such that the holographic image display unit is operable to display the holographic image based on the control signal. Thus, for example, referring to FIGS. 1 to 5, mobile device 140, 460 or 560 or system 100, 400 or 500 may undertake one or more of the blocks shown in FIG. 6 in response to instructions 804.

In some implementations, signal bearing medium 802 may encompass a computer-readable medium 806, such as, but not limited to, a hard disk drive, a Compact Disc (CD), a Digital Video Disk (DVD), a digital tape, memory, etc. In some implementations, signal bearing medium 802 may encompass a recordable medium 808, such as, but not limited to, memory, read/write (R/W) CDs, R/W DVDs, etc. In some implementations, signal bearing medium 802 may encompass a communications medium 810, such as, but not limited to, a digital and/or an analog communication medium (e.g., a fiber optic cable, a waveguide, a wired communications link, a wireless communication link, etc.). Thus, for example, program product 800 may be conveyed to one or more modules of mobile device 140, 460 or 560 or system 100, 400 or 500 by an RF signal bearing medium 802, where the signal bearing medium 802 is conveyed by a wireless communications medium 810 (e.g., a wireless communications medium conforming with the IEEE 802.11 standard).

In some embodiments, a mobile device is configured to display a holographic image on a holographic image display unit using a light source station to illuminate the holographic image display unit. Generation of a holographic image may include reflection of a reference beam, provided by the light source station, from a display showing a representation of CGH data. A mobile device may comprise a receiver configured to receive a control signal from the light source station such that the holographic image display unit is time-synchronized with the light source station. Time synchronization may include provision of a coherent reference beam synchronously with the displayed holographic image. In some embodiments, a holographic image display unit may include an SLM (spatial light modulator), from which in some examples the reference beam may be reflected. An example SLM may include a liquid crystal display, micromirror display, electrochromic display, or other electrically controlled display, and may include a reflective element. A mobile device may include one or more of a display driver, processor, memory, and a data receiver configured to receive, for example, CGH data for viewing on the holographic image display unit. CGH data may be stored in memory, received over cellular or Wi-Fi communications links, and the like.

A light source station may be configured to exchange a control signal with the mobile device. In some examples, the light source station may transmit a control signal to a receiver of the mobile device. In some examples, the control signal may include data relating to the phase of the reference beam, and may convey other data such as the type of light source station (e.g. coherent or incoherent beam, laser, white light, or other spectral or light source type data), allowing the mobile device to improve display quality through modification of CGH data and phase thereof in response to the control signal. In some examples, the light source station may receive a control signal from the mobile device, and a light signal of the light source station may then be adjusted to be time-synchronized with the holographic image display unit. For example, a reference beam phase may be adjusted, for example through electrical control of a light source, introduction of phase delay elements, and the like. A wirelessly-exchanged control signal allows the holographic image display unit to be viewed with higher quality, even when a mobile device moves within an area of illumination of a light source stations, or between such regions. In some embodiments, a light source station is configured to perform a handover operation between the light source station and a second light source station, for example as a user carrying a mobile device moves from an area of illumination of the light source station to an area of illumination of the second light source station.

In some embodiments, a light source station may be configured to track a location of the holographic image display unit and direct a reference beam towards the holographic image display unit. Tracking may be achieved using one or more of various approaches, such as image recognition, detection of the direction of signals, such as wireless signals, from the mobile device, detection of a graphic symbol on the mobile device, and the like. A light source station may be configured to determine the distance between the light source station and the holographic display unit, for example using signal delay times, IR or visible ranging, ultrasound ranging, and the like. The distance data may be used to control the brightness, phase, and/or focus distance (if any) of a reference beam. For example, a light source station may include an image sensor configured to track the location of the holographic image display unit, for example using image analysis software executed by an associated processor.

In some embodiments, a light source station may include a beam steering device, such as a lens, prism, electrooptical element, phase array optics, grating, mirror, or other beam steering element, and/or may have a housing configured to be reoriented such that the reference beam is directed towards the mobile device. In some examples, a reference beam from a light source station may physically track the mobile device as the mobile device moves relative to the light station location. In some examples, one or more light sources from a plurality of available light sources having different reference beam directions are selected and energized to illuminate the mobile device. In some examples, a light source station may be supported by a ceiling of a room, on a pole (such as a post or similar elevated support), on a wall or other building element, in a furniture item such as a chair (such as within or supported by an armrest or headrest), within a vehicle, provided as or part of a lamp (such as a desk lamp, ceiling light, and the like), as part of a body mounted item (e.g. as part of a device supported on a head, such as spectacles, wrist-mounted device, pendant, or similar), supported in or by a clothing item, or otherwise provided. A light source station may provide one or more separately steerable reference beams.

In some embodiments, a mobile device is configured to receive a control signal from one or more light source stations. The choice of light source station, if a plurality are available, may be selected based on one or more parameters such as device location, orientation of the display (for example, based on incident angle), light source type, and the like. A mobile device may receive a control signal using any suitable wireless communications approach, such as wireless communications protocols, IR, and the like. A mobile device may be configured to establish a wireless communications link between the mobile device and the light source station. In some embodiments, the mobile device is configured to receive the control signal using an in-band communication channel in the reference beam. In some examples, a control signal may be encoded in a reference beam, for example using optical modulation (e.g. amplitude, frequency, polarization, and the like).

In some embodiments, the reference beam is (or includes) a laser beam. A light source station may include a plurality of lasers, such as visible light emitting lasers. A light beam, such as a laser beam, may be directed from the light source station towards the mobile device by one or more of various approaches, such as mechanical reorientation of a light source station and/or an associated light source thereof, beam steering using one or more of a refractive, diffractive, or reflective element (such as a lens, grating, hologram, mirror, and the like), beam steering using a mechanically adjustable waveguide (such as an optical fiber), and the like.

In some embodiments, a holographic image display unit is configured to convert a holographic image into a two-dimensional image when an appropriate reference beam is not available. For example, a mobile device may determine that a light source station is not available, for example due to the absence of a light source station, a failure of the light source station to detect or track the location of the holographic image display unit, failure to exchange a control signal with the light source station, absence of a particular light source type from the light source station, and the like.

In some embodiments, a holographic image display unit may be configured to record a holographic image (or time-sequential sequence thereof) using the reference beam from a light source station. For example, the mobile device may further be configured as a holographic camera and/or video recorder. A light source station may provide a reference beam for either recording of holographic data, or reconstruction of a holographic image on a display.

In some embodiments, a light source station is configured to control accessibility of the mobile device. For example, a reference beam may be used that restricts the field of view of the holographic display, provides a low contrast or low resolution display, or other approach. In some examples, a mobile device may transmit a request signal to the light source station to increase or decrease light intensity, or otherwise adjust the reference beam properties. In some examples, a user may adjust reference beam properties using controls provided by the mobile device, and signals transmitted from the mobile device to the light source station.

In some embodiments, information relating to the light source station may be detected by the mobile device. The information may relate to the reference beam provided by the light source station such as spectral data (such as center wavelength, bandwidth (degree of monochromacity), spectral characteristics, and the like), beam intensity (such as total beam intensity, beam intensity within one or more spectral ranges, and the like), coherence data (such as coherence length), polarization, phase data (such as the phase of a coherent reference beam relative to other time-dependent parameters, such as displayed CGH data), modulation (if any), physical configuration data (such as the distance of the light source station from the display, physical extent (e.g. area) of the reference beam at the display, physical extent of the reference beam source within the light source station, incidence angle of a reference beam on the display), display size, similarities and differences between the reference beam parameters and those of the reference beam used to record the holographic data, and the like. The information may include an identification of the light source type(s) included in the light source station, such as a white light source, laser, LED, fluorescent lamp, halogen lamp, or solar radiation derived from a sunlit location. In some examples, a mobile device user may select a desired light source type from a menu displayed on the mobile device, or otherwise input and/or select a requested light source type into the mobile device.

In some embodiments, information on the light source station is determined by a mobile device, for example from information encoded in the control signal, by detection of the light source properties, or from a user input. In some embodiments, light source station information may be encoded in a reference beam. In some examples, a light source station may generate relatively weak beams until a reference beam is requested, and then provide a more intense beam as required. If the reference beam used by a display unit changes (for example, by relocation to the illumination area of a different light source station), revised information on the light source station in use may be determined by the mobile device. In some examples, the phase of the electrical signals used to drive the holographic image display may be adjusted to match the phase of light generation (e.g laser light generation) from a light source station, using the control signal provided by the light source station. In other examples, the phase of light from a light source station may be adjusted to match that of electrical signals used to drive the holographic image display, for example using a control signal provided by the holographic image display. In some examples, phases of both the electrical signals and light generation may be adjusted to match each other. Using one or more of such approaches, the phase of light from a light source may be time-synchronized (or phase-locked) with the holographic image display unit (e.g., phase locked with electrical signals, e.g. from a display drivers, used to drive an electronic display such as an SLM). A control signal may include phase information of the light source, and, for example, an phase adjustment circuit associated with the holographic image display may be used to adjust the phase of electrical signals used to drive the display, in response to the control signal. For example, the phase of a clock circuit may be adjusted in response to the control signal. In some examples, the control signal travels substantially the same distance as the reference beam, so any distance effect in the reference beam travel may be compensated for. In some examples, a sensor in the mobile device may detect the phase of the reference beam at the mobile device and make adjustments (possibly further adjustments in addition to previous adjustments made based on a control signal) to the phase of electrical signals used by the display. In some embodiments, CGH data for the display may be calculated (or adjusted) based on information relating to the light source station. In some embodiments, the mobile device itself may modify CGH data based on the information relating to the reference beam, improving the holographic images displayed. In some embodiments, CGH data provided by a server device in communication with the mobile device (acting as a client device) may modify the CGH data based on the received information relating to the light source station.

The present disclosure is not to be limited in terms of the particular embodiments described in this application, which are intended as illustrations of various aspects. Many modifications and variations may be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A system configured to display a holographic image, the system comprising:
a mobile device including a holographic image display unit; and
a light source station configured to track a location of the holographic image display unit and provide a reference beam towards the holographic image display unit, wherein the light source station is further configured to exchange a control signal with the mobile device such that the holographic image display unit is operable to display the holographic image based on the control signal.

2. The system of claim 1, wherein the holographic image display unit includes an SLM (spatial light modulator).

3. The system of claim 1, wherein the mobile device is configured to receive the control signal from the light source station over a communication channel.

4. The system of claim 3, wherein the mobile device is further configured to establish the communication channel including at least one of Bluetooth, Zigbee, RFID, Wi-Fi, or cellular network.

5. The system of claim 3, wherein the mobile device is further configured to establish the communication channel including an in-band communication channel in the reference beam.

6. The system of claim 1, wherein the mobile device is configured to establish a wireless communications link between the mobile device and the light source station.

7. The system of claim 1, wherein the light source station is configured to provide a laser beam or a white light as the reference beam.

8. The system of claim 1, wherein the light source station includes an image sensor configured to track the location of the holographic image display unit.

9. The system of claim 1, wherein the holographic image display unit is configured to convert the holographic image into a two-dimensional image when the light source station determines that the location of the holographic image display unit fails to track.

10. The system of claim 1, wherein the holographic image display unit is configured to convert the holographic image into a two-dimensional image when the mobile device determines that the control signal is not received by the mobile device.

11. The system of claim 1, wherein the holographic image display unit is configured to record a holographic image based on the reference beam.

12. The system of claim 1, wherein the light source station is configured to control accessibility of the mobile device.

13. The system of claim 1, wherein the system includes a plurality of light source stations that includes the light source station and a second light source station.

14. The system of claim 13, wherein the plurality of light source stations is configured to track the mobile device.

15. The system of claim 13, wherein the mobile device is configured to perform a handover operation between the light source station and the second light source station.

16. The system of claim 13, wherein the plurality of light source stations is configured to perform a handover operation between the plurality of light source stations.

17. A method of displaying a holographic image, the method comprising:
tracking, by one or more light source stations, a location of a mobile device including a holographic image display unit;
providing, by the one or more light source stations, a reference beam towards the holographic image display unit; and
exchanging, by the one or more light source stations, a control signal with the mobile device.

18. The method of claim 17, further comprising:
displaying, by the holographic image display unit, the holographic image based on the control signal.

19. The method of claim 17, further comprising:
establishing, by the mobile device, a communication channel with at least one of the one or more light source stations, the communication channel being used for transmitting the control signal.

20. The method of claim 17, wherein the tracking comprises tracking, by an image sensor, the location of the holographic image display unit.

21. The method of claim 17, further comprising:
converting, by the holographic image display unit, the holographic image into a two-dimensional image when the one or more light source stations determine that the location of the holographic image display unit fails to track.

22. The method of claim 17, further comprising:
recording, by the holographic image display unit, a holographic image based on the reference beam.

23. The method of claim 17, further comprising:
controlling, by the one or more light source stations, accessibility of the mobile device.

24. The method of claim 17, further comprising:
performing, by the mobile device, a handover operation between the one or more light source stations.

25-30. (canceled)

31. A mobile device configured to display a holographic image with a reference beam provided from a light source station, the mobile device comprising:
a holographic image display unit configured to receive the reference beam and display the holographic image responsive to the reference beam; and
a receiver configured to receive a control signal from the light source station such that the holographic image display unit is time-synchronized with the light source station responsive to the control signal.

32-38. (canceled)

39. A light source station for providing a time-synchronized reference beam for a holographic image display unit, the light source station comprising:
a reference beam source, configured to generate a reference beam;
a directional controller, operable to control a direction of the reference beam;
a control signal generator, operable to generate a control signal;
a holographic display detection unit, operable to detect the holographic image display unit within an environment of the light source station and provide display detection data; and
a control circuit, wherein the control circuit is operable to energize the reference beam source to produce the reference beam, and to provide direction control signals to the directional controller to direct the reference beam towards the holographic image display unit using the display detection data.

40-46. (canceled)
